(19) United States
(12) Patent Application Publication
(10) Pub. No.: US 2007/0159018 A1
(43) Pub. Date: Jul. 12, 2007

(54) Explosion-proof motor

(76) Inventors: Jerry L. Martin, Gainesville, GA (US); Barron D. Grant, Gainesville, GA (US); Douglas Crumley, Gainesville, GA (US); Thomas S. Cufr, Gainesville, GA (US)

Correspondence Address: ROCKWELL AUTOMATION, INC./(FY), ATTENTION: SUSAN M. DONAHUE, E-7F19, 1201 SOUTH SECOND STREET, MILWAUKEE, WI, 53204, US

(21) Appl. No.: 11/329,804

(22) Filed: Jan. 11, 2006

(51) Int. Cl. H02K 9/00; H02K 5/10; H02K 1/00

(52) U.S. Cl. 310/88; 310/217; 310/216; 310/58

(57) ABSTRACT

A novel explosion-proof motor, which, in certain embodiments, features a housing with flame paths between various joints in the housing. These flame paths may contain and cool hot gases and flames produced by a detonation within the housing. In certain embodiments, the explosion-proof motor includes a stator having a plurality of laminations and an end ring. The end ring may have a generally circumferential surface to interface with other components of the housing. The explosion-proof motor may also include an end-bracket having a second generally circumferential surface configured to mate with the end ring. The mating circumferential surfaces of the end-ring and the end-bracket may form a flame path to prevent the propagation of an internal detonation.

### BACKGROUND

The invention relates generally to electric motors. More specifically, the invention relates to a housing for an explosion-proof electric motor.

Often, electric motors operate in an explosive environment. For example, electric motors power machinery in and near coal mines, where coal dust and methane are often concentrated. Similarly, electric motors operate in explosive environments in grain silos with explosive grain dust and in chemical plants processing volatile chemicals.

Unfortunately, in these explosive environments, an explosion within an electric motor may propagate to the surrounding environment. During operation, the explosive material in the surrounding environment may diffuse into the interior of the electric motor, and heat or sparks within the motor may ignite the material, causing an internal detonation. Hot exhaust gases or flames produced by the internal detonation may escape the motor housing and ignite combustible material in the surrounding environment. As a result, the detonation that began inside the electric motor may spread, thereby potentially leading to a larger explosion.

Accordingly, there is a need for an explosion-proof motor.

### BRIEF DESCRIPTION

The present invention provides, in certain embodiments, a novel explosion-proof motor. The explosion-proof motor may feature a housing with flame paths between various joints in the housing. These flame paths may contain and cool hot gases and flames produced by a detonation within the housing. In certain embodiments, the explosion-proof motor includes a stator having a plurality of laminations and an end ring. The end ring may have a generally circumferential surface to interface with other components of the housing. The explosion-proof motor may also include an end-bracket having a second generally circumferential surface configured to mate with the end ring. The mating circumferential surfaces of the end-ring and the end-bracket may form a flame path to prevent the propagation of an internal detonation.

### DRAWINGS

These and other features, aspects, and advantages of the present invention will become better understood when the following detailed description is read with reference to the accompanying drawings in which like characters represent like parts throughout the drawings, wherein:

FIG. 1 is a partially-sectioned, side-profile view of an explosion-proof motor in accordance with an embodiment of the present technique;

FIG. 2 is another partially-sectioned, side-profile view of an explosion-proof motor in accordance with an embodiment of the present technique;

FIG. 3 is a cross-sectioned, side-profile view of a front end-bracket in accordance with an embodiment of the present technique;

FIG. 4 is a front-profile view of the front end-bracket in accordance with an embodiment of the present technique;

FIG. 5 is a plan view of the front end-bracket in accordance with an embodiment of the present technique;

FIG. 6 is an enlarged view of a flame path in accordance with an embodiment of the present technique;

FIG. 7 is a cross-sectioned construction view of a stator in accordance with an embodiment of the present technique; and

FIG. 8 is a front-profile view of a lamination in accordance with an embodiment of the present technique.

### DETAILED DESCRIPTION

The following discussion describes an explosion-proof motor. As is described in greater detail below, in certain embodiments, the explosion-proof motor includes a housing with joints that contain and cool hot exhaust gases and flames resulting from a detonation within the explosion-proof motor. Advantageously, containing and cooling these hot exhaust gases may reduce the likelihood of an internal explosion igniting combustible material in the surrounding environment.

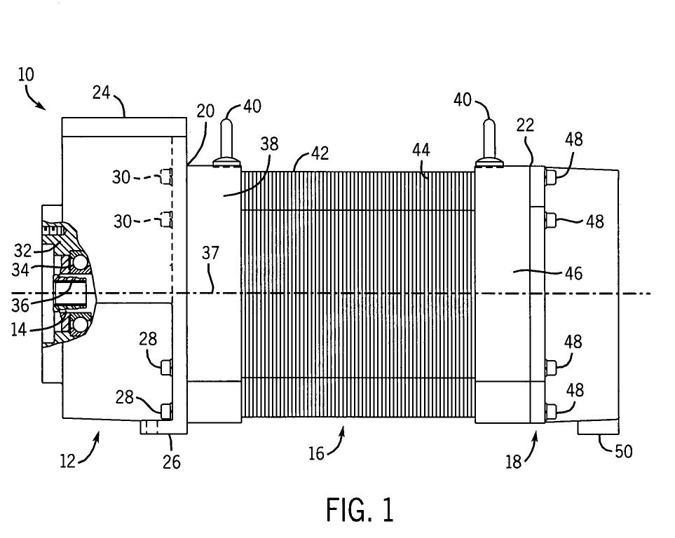

FIG. 1 depicts a side-profile view of an exemplary explosion-proof motor 10. The illustrated explosion-proof motor 10 includes a front end-bracket 12, a shaft 14, a stator 16, and a rear end-bracket 18. The front end-bracket 12 and the rear end-bracket 18 couple to opposing ends of the stator 16, thereby forming a housing. As is described in greater detail below, the interfaces between the front end-bracket 12, the stator 16, and the rear end-bracket 18 form flame paths 20 and 22. Advantageously, these flame paths 20 and 22 may contain and cool exhaust gases and flames produced by a detonation within the explosion-proof motor 10, as is described further below. Additionally, in the present embodiment the front end-bracket 12 and the rear end-bracket 18 rotatably support the shaft 14.

As used herein, the term “flame path” refers to a joint between two components of a motor housing that satisfy certain standards pertaining to explosion-proof motors. For example, the joint may satisfy the requirements promulgated by the Underwriters Laboratories for class I explosion-proof motors or class II explosion-proof motors. In other words, the term “flame path” refers to a junction between two components in a motor housing that is sufficiently tight and sufficiently long that an explosion within the motor housing is unlikely to propagate to the surrounding environment through the junction.

The illustrated motor 10 is an alternating current electric induction motor. However, in other embodiments, the motor 10 may be a brushless direct current motor, a servo motor, a brushless direct current servo motor, a brushless alternating current servo motor, a stepper motor, or a linear motor, for example. The explosion-proof motor 10 may employ a number of electromagnets and/or permanent magnets to convert electrical energy into mechanical energy, as described below.

The exemplary front end-bracket 12 features a cover 24, feet 26, fasteners 28, internal fasteners 30, and a bearing support 32. The cover 24 may couple to the top of the front end-bracket 12 and facilitate access to components within the front end-bracket 12. The illustrated feet 26 extend from the bottom of the front end-bracket 12 and may support the explosion-proof motor 10. The illustrated fasteners 28 and internal fasteners 30 secure the front end-bracket 12 to the stator 16. In the present embodiment, the fasteners 28 and the internal fasteners 30 include bolts and complementary threaded apertures. However, as will be appreciated, other embodiments may employ other types of fasteners, such as a welded joint, snap rings, rivets, an interference fit, or any other mechanism adapted to secure the front end-bracket 12 to the stator 16. The front end-bracket 12 houses the internal fasteners 30. The illustrated bearing support 32 holds a bearing 34 that rotatably supports the shaft 14. In the present embodiment, the bearing support 32 is integrally formed in the front end-bracket 12.

The exemplary shaft 14 terminates with a threaded coupling 36 and rotates about an axis of rotation 37. In the present embodiment, the threaded coupling 36 resides at a distal end of the shaft 14 adjacent the front end-bracket 12. The shaft 14 may transfers mechanical energy from the explosion-proof motor 12 by rotating about axis of rotation 37. Various other components may couple to the shaft 14 through an interface secured by the threaded coupling 36.

The illustrated stator 16 includes a front end ring 38, eye bolts 40, a core 42 composed of laminations 44, and a rear end ring 46. As is described in greater detail below, the front end ring 38 and the rear end ring 46 may cooperate to compress the core 42 along the axis of rotation 37. A plurality of laminations 44 placed side by side form the core 42, and the front end ring 38 and the rear end ring 46 hold the laminations in place. Eye bolts 40 coupled to the front end ring 38 and the rear end ring 46 may facilitate movement of the explosion-proof motor 10. The illustrated stator 16 couples to the front end-bracket 12 through the front end ring 38 and to the rear end-bracket 18 through the rear end ring 46.

The present rear end-bracket 18 features fasteners 48 and feet 50. Fasteners 48 secure the rear end-bracket 18 to the rear end ring 46, and feet 50 support a portion of the explosion-proof motor 10. While the illustrated fasteners 48 are bolts and threaded apertures, other embodiments may employ other types of fasteners, such as those discussed above in reference to internal fasteners 30.

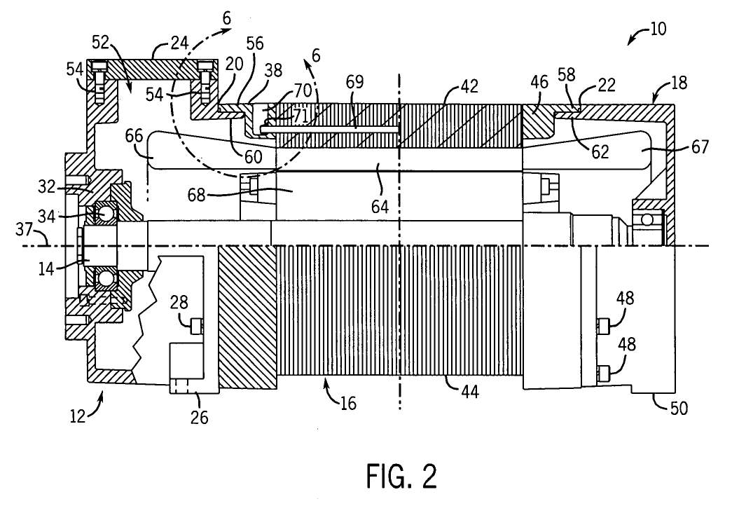

FIG. 2 depicts a partially-sectioned view of the explosion-proof motor 10. As illustrated by FIG. 2, the present front end-bracket 12 also includes a front access aperture 52 and cover fasteners 54. The front access aperture 52 may facilitate access to the interior of the front end-bracket 12. For example, in the present embodiment, the internal fasteners 30 and electrical connections in the front end-bracket 12 may be accessed through the front access aperture 52. The illustrated cover fasteners 54 are bolts and threaded apertures, but, in other embodiments, the cover fasteners 54 may include other devices for securing the cover 24, such as those discussed above in reference to the internal fasteners 30.

FIG. 2 depicts both flame path 20, i.e., the interface between the front end-bracket 12 and the front end ring 38, and flame path 22, i.e., the interface between the rear end-bracket 18 and the rear end ring 46. In the present embodiment, the front end ring 38 includes a front extension 56, and the rear end ring 46 includes a rear extension 58. Complementing these extensions 56 and 58, the front end-bracket 12 includes a front mating-extension 60, and the rear end-bracket 18 includes a rear mating-extension 62. The illustrated extensions 56 and 58 and mating-extensions 60 and 62 are generally annular members that are generally circumferentially disposed about the axis of rotation 37. The illustrated front extension 56 is concentrically disposed about the front mating-extension 60, and the illustrated rear extension 58 is concentrically disposed about the rear mating-extension 62. Of course, in other embodiments, one or both of the positions of the extensions 56 and 58 and mating-extensions 60 and 62 may be reversed, with the mating-extensions 60 and/or 62 concentrically disposed about the extensions 56 and/or 58.

The illustrated stator 16 supports a coil 64 with a front coil head 66 and a rear coil head 67. In the present embodiment, the front coil head 66 extends from the stator 16 into a volume within the front end-bracket 12, and the rear coil head 67 extends from the stator 16 into a volume within the rear end-bracket 18. In other embodiments, permanent magnets may be used instead of or in combination with the coil 64.

A rotor 68 disposed within the stator 16 drives the shaft 14. The rotor 68 may include various windings and/or permanent magnets that cooperate with electromagnetic fields generated by the stator 16 to drive the shaft 14. The rotor 68 rotates with the shaft 14 about the axis of rotation 37.

In the present embodiment, tie-rods 69 bind the components of the stator 16 together. A number of tie-rods 69, such as 12, pass through the core 42, extending into the front end ring 38 and the rear end ring 46. The distal ends of the tie-rods 69 extend into weld access apertures 70. Weldments 71, formed within weld access apertures 70, secure the tie-rods 69 to the front end ring 38 and the rear end ring 46. As is described in greater detail below, in some embodiments, the core 42 is pre-compressed before the tie-rods 69 are welded to the end rings 38 and 46, thereby placing the tie-rods 69 in tension and the core 42 in compression when the pre-compressive force is removed.

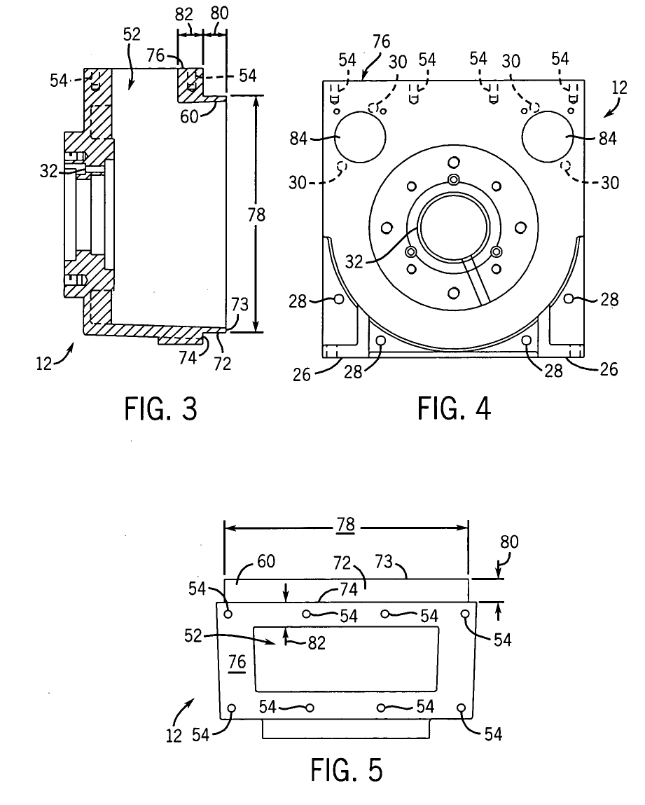

FIG. 3 illustrates a cross-sectional side view of a front end-bracket 12 in accordance with an embodiment of the present technique. The illustrated front mating-extension 60 forms an outer diameter surface 72 and an inner surface 73. The present front mating-extension 60 extends from an outer surface 74 of the front end-bracket 12. In the illustrated embodiment, the outer diameter surface 72 is generally orthogonal to both the inner surface 73 and the outer surface 74. However, in other embodiments, the outer diameter surface 72 may extend from the surfaces 73 and/or 74 at some other angle. The illustrated outer diameter surface 72 generally follows the perimeter of a circle with an outer diameter dimension 78. In certain embodiments, the outer diameter dimension 78 may range from 10 to 14 inches or 5 to 20 inches and have a tolerance of less than 0.001 inches, 0.002 inches, 0.003 inches, 0.004 inches, 0.005 inches, or 0.01 inches, for instance. The front mating-extension 60 may extend through an extension length 80. In certain embodiments, the extension length may range from 1.21 to 1.23 inches, 1.20 to 1.24 inches, 1.19 to 1.25 inches, 1.18 to 1.26 inches, 1.17 to 1.27 inches, 1.12 to 1.32 inches, or 0.5 to 1.8 inches, for example. A top surface 76 of the front end-bracket 12 may extend through a top surface width 82, ranging from 1.33 to 1.35 inches, 1.32 to 1.36 inches, 1.31 to 1.37 inches, 1.30 to 1.38 inches, 1.29 to 1.39 inches, or 1.0 to 1.8 inches, in various embodiments, for example. Advantageously, a top surface width 82 and an extension length 80 of sufficient length may reduce the likelihood of hot gases or flames escaping after a discharge within the explosion-proof motor 10 and/or cool these gases and flames before they exit the explosion-proof motor 10. Thus, the top surface 76 may also form a flame path.

FIG. 4 illustrates a front-profile view of the front end-bracket 12. Power cables and/or winding leads may pass through cable outlets 84 in the front end-bracket 12. In some embodiments, covers, packing glands, or plugs seal one or both cable outlets 84.

FIG. 5 illustrates a plan view of the front end-bracket 12. As illustrated by FIG. 5, the front access aperture facilitates access to the interior of the front end-bracket 12.

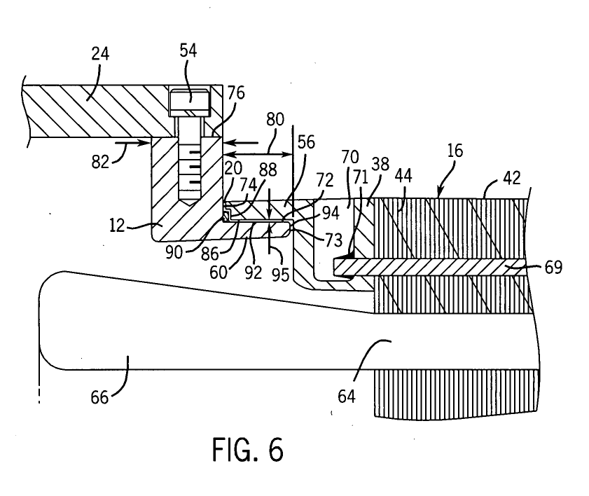

FIG. 6 is an expanded view of the flame path 20, which is representative of flame path 22. In the present embodiment, the interface between the front end-bracket 12 and the front end ring 38 forms the flame path 20. A notch 88 in the front extension 56 holds a seal 90. The illustrated seal 90 at least partially obstructs the flame path 20. Advantageously, in the event of a detonation within the explosion-proof motor 10, the seal 90 may prevent some hot exhaust gases and flames from escaping from the interior of the explosion-proof motor 10. Of course, other embodiments may employ multiple seals 90 or no seals 90. The illustrated flame path 20 has a flame path width 95. In the present embodiment, the flame path width 95 is the distance between the outer diameter surface 72 of the front mating-extension 60 and an inner diameter surface 86 of the front extension 56. In certain embodiments, the flame path width 95 ranges from 0.003 to 0.005 inches, 0.002 to 0.007 inches, 0.001 to 0.008 inches, or 0.000 to 0.009 inches, for example. The illustrated flame path 20 includes a tubular portion 92 and an annular portion 94. The annular portion 94, in the present embodiment, extends radially inward from the end of the tubular portion 92. Of course, other embodiments in accordance with the present technique may not include a tubular portion 92, an annular portion 94, or both. Advantageously, hot exhaust gases or flames passing through the flame path 20 change direction when passing from the annular portion 94 to the tubular portion 92, thereby potentially obstructing the flow of the gases and flames and lowering the temperature of the gases and flames.

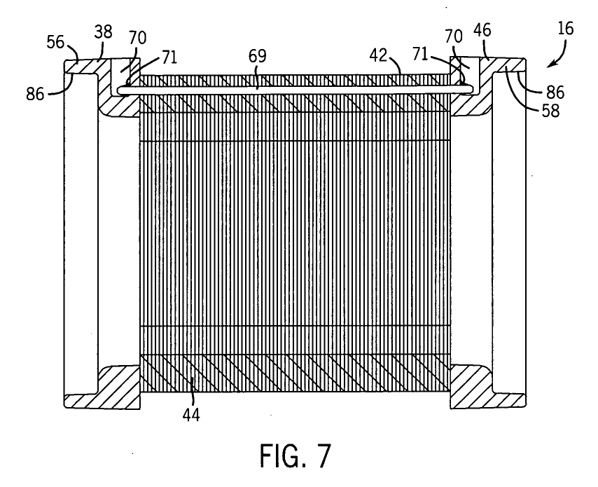

FIG. 7 is a cross-sectional construction view of a stator 16. The process for manufacturing the stator 16 will now be described. First, the laminations 44 align in a stack to form the core 42. Next, tie-rods 69 pass through the core 42, leaving the distal ends of the tie-rods 69 exposed. The front end ring 38 slides onto the tie-rods 69 at one end of the core 42, and the rear end ring 46 slides onto the tie-rods 69 at the other end of the core 42. Next, the entire assembly, including the end rings 38 and 46 and the core 42, is compressed. In some embodiments, the stator 16 is compressed with between 28 and 32 tons of pressure, 26 and 34 tons of pressure, 20 and 40 tons of pressure, or 15 and 45 tons of pressure, for example. While the stator 16 is compressed, the ends of the tie-rods 69 are welded to the end rings 38 and 46. Weld access apertures 70 facilitate the formation of weldments 71 between the tie-rods 69 and the end rings 38 and 46, as the ends of the tie rods 69 are accessible through the weld access apertures 70. Next, the compressive pressure on the stator 16 is removed, leaving the tie-rods 69 to hold the stator 16 in a compressed state. As a result, tension within the tie-rods 69 biases the core 42. Finally, the exterior surface of the core 42 is peened or cold worked to fuse the laminations 44 together. Advantageously, compressing and fusing the laminations 44 may reduce the likelihood of hot gases and flames escaping from within the explosion-proof motor 10 in the event of an internal discharge. Other techniques may be used to maintain the stator or frame elements as a tight unit, such as threaded tie rods, external welds, and so forth.

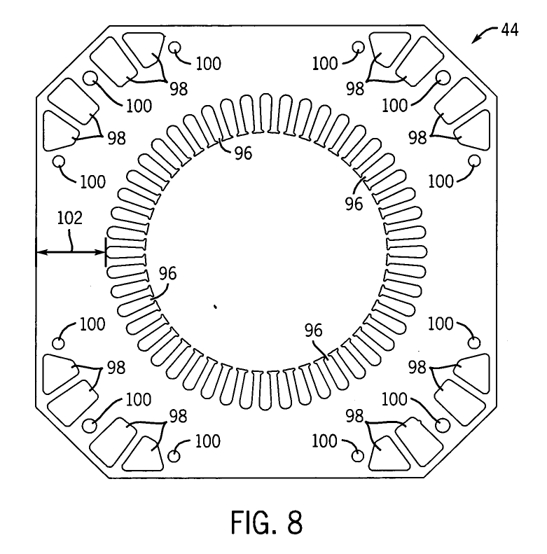

FIG. 8 illustrates a front-profile view of a lamination 44. The lamination 44 may be stamped from a sheet of metal into the shape generally depicted by FIG. 8. Coil channels 96 may support and position coils 64, and cooling channels 98 may conduct air through the core 42. Tie-rod apertures 100 may support tie-rods 69. In the present embodiment, a stack of laminations 44 form the core 42.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An alternating current, explosion-proof motor comprising:
a stator including a plurality of laminations and an end ring, the end ring having a first generally circumferential surface; and
an end-bracket having a second generally circumferential surface configured to mate with the first generally circumferential surface of the stator end ring to form a flame path therebetween.

2. The motor of claim 1, wherein the first generally circumferential surface is radially inside the second generally circumferential surface.

3. The motor of claim 1, wherein the end-bracket includes a bearing support for supporting a rotor of the motor.

4. The motor of claim 1, wherein the end-bracket is secured to the end ring of the stator via a plurality of bolts, and wherein at least one of the plurality of bolts is disposed within a volume formed within the end-bracket.

5. The motor of claim 1, wherein the end-bracket at least partially houses windings of the stator in within a volume formed within the end-bracket.

6. The motor of claim 1, wherein an exterior surface of the laminations has a peened finish to resist delamination during a discharge within the motor.

7. The motor of claim 1, wherein the flame path includes a sealing member.

8. The motor of claim 1, wherein the flame path comprises a surface with a generatrix that is substantially non-perpendicular to an axis of rotation of a rotor.

9. An alternating current, explosion-proof motor comprising:
a stator including a plurality of laminations and forming an external frame of the motor;
an end-ring disposed at an end of the plurality of laminations;
an end-bracket coupled to the end-ring; and
a flame path between the end-bracket and end-ring, wherein a substantial portion of the flame path comprises a first surface with a generatrix that is not generally perpendicular to an axis of rotation of a rotor.

10. The motor of claim 9, further comprising a plurality of tensile members, wherein the plurality of laminations and the end-ring form an integrated structure joined by the plurality of tensile members.

11. The motor of claim 10, wherein the first surface forms a tubular portion of the flame path.

12. The motor of claim 11, wherein the flame path is formed between a first generally circumferential surface of the end ring and a second generally circumferential surface of the end-bracket.

13. The motor of claim 12, wherein the first generally circumferential surface is radially inside the second generally circumferential surface.

14. The motor of claim 9, wherein an exterior surface of the laminations has a peened finish to resist delamination during a discharge within the motor.

15. An explosion-proof motor, comprising:
a rotor with an axis of rotation;
a frame disposed around the rotor, the frame including an extension that extends generally parallel to the axis of rotation;
an end-bracket including a mating-extension configured to mate with the extension to form a flame path therebetween.

16. The motor of claim 15, wherein the extension is generally circumferential.

17. The motor of claim 15, wherein the flame path includes a tubular portion and an annular portion.

18. The motor of claim 15, wherein the frame or the rotor includes a permanent magnet.

19. The motor of claim 15, wherein the mating-extension is disposed radially inside the extension.

20. The motor of claim 15, wherein the frame includes a winding, and wherein the end-bracket at least partially houses the winding.
